(19) United States
(12) Patent Application Publication
(10) Pub. No.: US 2011/0055908 A1
(43) Pub. Date: Mar. 3, 2011

(54) SYSTEM AND METHOD FOR REMOTELY ACCESSING AND CONTROLLING A NETWORKED COMPUTER

(75) Inventor: Andrew Cheung, Toronto (CA)

(73) Assignee: O1 COMMUNIQUE LABORATORY INC., Mississauga (CA)

(21) Appl. No.: 12/690,348

(22) Filed: Jan. 20, 2010

(30) Foreign Application Priority Data
Aug. 25, 2009 (CA) 2677113

(51) Int. Cl. G06F 15/167; G06F 17/30

(52) U.S. Cl. 726/5; 709/212; 709/227

(57) ABSTRACT

The present invention advantageously provides a system and method for remotely accessing a networked computer. The system includes a personal computer, a locator server, a remote access terminal, and a connection key. The system is configured to remote access to only those users who are authorized and use authorized remote access terminal and connection key. In some embodiments, the connection key is configured to automate communication requests and authentication processes without user interaction.

### PRIORITY CLAIM

This application claims the benefit of Canadian patent application serial number 2,677,113 filed Aug. 25, 2009.

### FIELD OF THE INVENTION

The present invention relates generally to remote access and control of a networked computer. More particularly, the present invention relates to a system and method for remotely accessing data on a networked computer and controlling the computer.

### BACKGROUND OF THE INVENTION

The development of the Internet and portable computers has allowed the growth of portable computing. In particular, remote access systems and programs have been developed to allow a user to utilize the Internet and a portable computer to remotely access a home or office computer. In the business context, remote access/control capabilities enable an employee to access in-office computer resources through a web-enabled corporate laptop while traveling.

A concern with the traditional remote access setup is security breaches. For example, when a traveler goes on a business trip and inadvertently loses a corporate laptop, confidential information stored on the laptop, such as client lists, may be compromised. Configuration files stored on the laptop, e.g., user login and password, may be misappropriated the same way. When a third party subsequently uses the stolen login and password to remotely access the traveler's corporate computer account, sensitive company information stored on corporate computers is further at risk of exposure.

Similar security risks exist when the traveler accesses his home or corporate computer remotely through a public kiosk at airports and hotels. If such public terminals have inadequate security measures the traveler's personal information can be exposed. Similar consequences to those in the case of a stolen/lost laptop can result.

The development of the Internet has also allowed for the creation of e-mail and the sharing of files through e-mail. Because of the risks inherent with receiving certain types of attachments, e.g., executable (.exe) files, many e-mail programs employ virus protection that blocks receipt of such files. Many e-mail programs also impose other limitations on e-mail attachments such as size limitations.

There are services such as www.sendthisfile.ca and products such as FTP servers whereby the user would have to first upload the attachment file to another location and then provide a link to the file into the email body so that the email recipient could click on the link to retrieve the file at that location. However, such services or products do not provide a link directly pointing to the original file with retrieval restriction and/or recipient physical authentication while there is no need to first upload the file to another location.

Furthermore, it is desirable to provide a method and system that provides improved security features that restrict remote access only to intended users, and to allow the intended users to remotely and securely access, control and manage data. It is also desirable to provide a system and method for sharing files that avoid existing limitations.

### SUMMARY OF THE INVENTION

The foregoing needs are met, to a great extent, by the present invention, wherein in one aspect a system is provided that in some embodiments allows a user to remotely and securely access, control and manage data.

In accordance with one embodiment of the present invention, a system includes a personal computer, a locator server, a remote access terminal, and a connection key. The personal computer can be linked to the Internet and associated with an IP address that cannot be reached publicly such as behind a corporate firewall, a Network Address Translator (NAT), router, gateway, etc. The locator server computer is linked to the Internet and associated with an IP address that can be reached publicly from the Internet such as a static public IP address. The personal computer is configured to send a signal that includes data for locating the personal computer. The locator server computer is configured to receive from the personal computer a signal that includes data for locating the personal computer. The remote access terminal is linked to the Internet and capable of sending requests for communication with the personal computer to the locator server computer. The connection key is configured to physically, electrically and removably connect with the remote access terminal.

The remote access terminal is configured to generate a request for communication with the personal computer based upon input from the connection key. In response at least in part to the request for communication with the personal computer, the locator server computer is configured to create one or more communication sessions between the personal computer and the remote access terminal based on the signal received at the locator server computer that includes data for locating the personal computer.

In accordance with another aspect of the present invention, a method for providing remote access or control to a personal computer is provided. The method includes receiving from a remote access terminal a request for communication with the personal computer. Authentication information from the remote access terminal is then received. The authentication information can at least partially be stored on a connection key physically, electrically and removably connected to the remote access terminal. One or more communication sessions between the remote access terminal and the personal computer are created based at least in part on the authentication information.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a system according to a preferred embodiment of the invention.

FIG. 2 is a detailed view of a remote access terminal according to a preferred embodiment of the invention.

FIG. 3 is a representation of an e-mail message also depicting a drop down menu having a menu item for secure attachments in accordance with an embodiment of the invention.

FIG. 4 is a representation of dialog box for creating a secure attachment link in accordance with an embodiment of the invention.

FIG. 5 is a flow chart depicting a method for providing remote access or control of a personal computer, in accordance with an embodiment of the present invention.

FIG. 6 is a flow chart depicting a method for providing remote access or control of a personal computer, in accordance with another embodiment of the present invention.

### DETAILED DESCRIPTION

The invention will now be described with reference to the drawing figures, in which like reference numerals refer to like parts throughout. An embodiment in accordance with one aspect of the present invention provides a system and method for providing remote access or control of a personal computer.

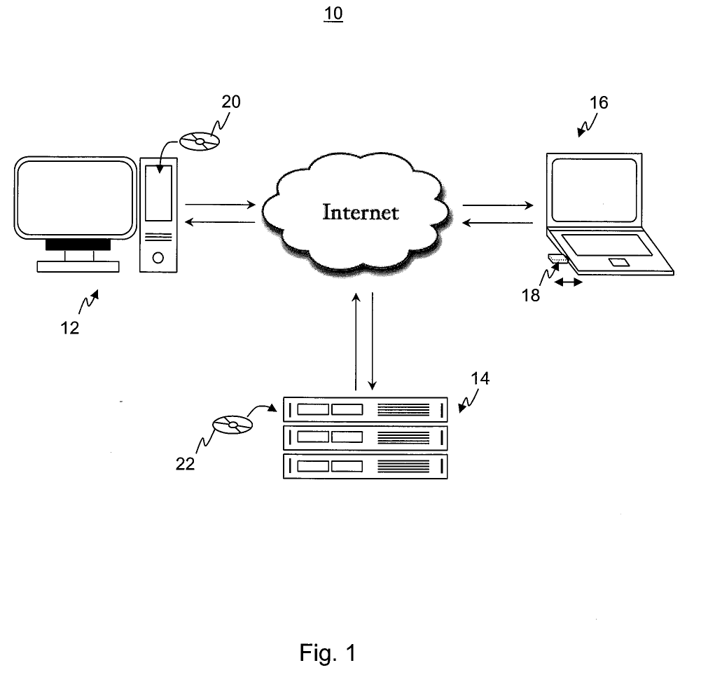

An embodiment of the present inventive system 10 is illustrated in FIG. 1. Generally, system 10 is an architecture that, through a combination of hardware and software, allows a user to remotely and securely access, control and/or manage data. More particularly, in one aspect system 10 includes security features that restrict remote access to only those users who are authorized and use authorized physical authentication devices. In some embodiments, system 10 further includes features that automate certain requests and authentication processes, as further discussed below. As depicted in FIG. 1, system 10 includes a personal computer 12, a locator server computer 14, a remote access terminal 16, and a USB device 18. In one embodiment, the USB device 18 serves as a connection key. As depicted, the connection key 18 can be embodied as a USB key, however, it is readily recognized that any device capable of storing such information and providing that information to the remote access terminal 16 to authenticate the user, can be used.

To implement physical security, remote access terminal 16 and connection key 18 serve as the physical authentication devices. Personal computer 12 and locator server computer 14 alone or in combination are configured to perform authorization routines to determine if at least one of a user of remote access terminal 16, and connection key 18 is authorized to access personal computer 12.

To implement the automation features, connection key 18 is configured to cause a request for communication with personal computer 12 to be generated by remote access terminal 16 upon connection thereto, thereby eliminating the need for a user to manually input the request. Here, connection key 18 “connects to” or is in “connection with” remote access terminal 16 when connection key 18 is “physically, electrically and removably connected” thereto. The process for authenticating a user can similarly be automated through pre-storing user identifiers (as discussed below) in connection key 18, thereby eliminating the need for a user to manually authenticate himself, such as by inputting a login ID and password.

Referring again to FIG. 1, personal computer 12 is configured in a manner such that a communication session can be established with a user who wishes to establish a remote connection session to the personal computer 12. Specifically, personal computer 12 is configured to send a signal that includes data for locating personal computer 12. In a preferred embodiment, personal computer 12 is provided with a (remote access) computer program product 20 that communicates the location of personal computer 12 on the Internet (e.g. dynamic IP address) to locator server computer 14 periodically. Through computer program product 20, the location of personal computer 12 can be sent to locator server computer 14, and used to connect the remote access terminal 16, upon its request for communication with personal computer 12, to personal computer 12. Further details relating to the components, use, and functions of computer program product 20, including a data communication facility and connection methods, are found in U.S. Pat. No. 6,928,479, the relevant disclosure of which is incorporated herein by reference. For remote access purposes, personal computer 12 may be a network station, a personal computer terminal, a virtual computer, or a server. Specifically, personal computer 12 can be associated with an Internet Protocol (IP) address that cannot be reached publicly. The term “cannot be reached publicly” is used in the sense that personal computer 12 does not have an addressable or accessible Internet location, e.g., its IP address cannot be accessed from the Internet because it is behind a network address translation (“NAT”) device, Internet gateway, firewall, etc. Alternatively the personal computer 12 can be associated with an Internet Protocol (IP) address that can be reached publicly from the Internet.

The request for communication with personal computer 12 (hereinafter a “communication request”) generated by remote access terminal 16 can be initiated through input by a user or input from connection key 18. In some embodiments, the communication request is generated by means of a user's entry in a Web page field or by an HTTP request that already contains the name of locator server computer 14. The user may be additionally prompted to enter an identifier (e.g. computer name) of personal computer 12 to be included in the communication request. Alternatively, the user may be prompted to enter authentication information, i.e. user identifier information (hereinafter “user identifier”) (e.g. user ID and password), to be included in the communication request. In other embodiments, the communication request generated by remote access terminal 16 is initiated by connection key 18, such as through executable codes stored therein, whereby the communication request is generated without user input. Still in other embodiments, the communication request can be initiated by a combination of user and connection key input for added security.

Locator server computer 14 acts as an intermediary between personal computer 12 and remote access terminal 16. Specifically, locator server computer 14 is configured to receive from personal computer 12 a signal that includes data for locating personal computer 12. In a preferred embodiment, locator server computer 14 is provided with a program product 22 for receiving information corresponding to the current location of personal computer 12 intermittently. As is readily understood, the functionality of the locator server computer 14 can be distributed over one or more devices in order to improve system operation in such areas as speed and efficiency. Further details relating to the components, use, and functions of the computer program product, including a location facility, are found in U.S. Pat. No. 6,928,479, the relevant disclosure of which is incorporated herein by reference. In a preferred embodiment, the I'm InTouch service provided by 01 Communique Laboratory, Inc. of Mississauga, Ontario provides the locator server.

In a security-enhanced configuration, locator server computer 14 can further include an authentication routine to validate the communication request. In a preferred embodiment, locator server computer 14 is configured to determine whether a) a user of remote access terminal, b) remote access terminal 16, and/or c) connection key 18 is authorized (to access personal computer 16). Locator server computer 14 is further configured to create and establish a communication session when the user of remote access terminal 16, connection key 18, and/or remote access terminal 16 is authorized. In alternative embodiments, locator server computer 14 is configured to first create the communication session in response to the communication request and before the authentication routine is performed, and to discontinue the communication session when the user of remote access terminal 16, connection key 18, and/or remote access terminal 16 is determined to be unauthorized.

Alternative embodiments for implementing the authentication routine can be used. In place of locator server computer 14, personal computer 12 can similarly be configured to determine whether the user, connection key 18, and/or remote access terminal 16 is authorized. Still in other embodiments, the configuration routine can be carried out by a combination of locator server computer 14 and personal computer 12.

Remote access terminal 16 provides a means for a user to remotely access, manage and control personal computer 12. Specifically, remote access terminal 16 is linked to the Internet and capable of generating communication requests.

Remote access terminal 16 is linked to the Internet through a wired or a wireless network. Examples of wired networks include local area networks (LANs), metropolitan area networks (MANs), and wide area networks (WANs). Examples of wireless networks include wireless local area networks (WLANs) and wireless wide area networks (WWANs). WLANs include systems using technologies such as Wi-Fi and other wireless protocols in accordance with IEEE 802.11 standards. WWANs include systems that operate in accordance with 2.5 G (such as cdma2000) and 3 G (such as UMTS and WiMax).

Remote access terminal 16 further provides for enhanced physical security. To serve as physical authentication, remote access terminal 16 includes unique remote access terminal identifier information (hereinafter “remote access terminal identifier”) that can be registered with locator server computer 14 as an authorized remote access terminal identifier. The registration can be set up locally by an administrator at locator server computer 14. Alternatively, the registration can be set up through a registration routine running on personal computer 12, as is well known, to communicate the remote access terminal identifier over the Internet to locator server computer 14. The remote access terminal identifier can be stored in a dynamic directory at locator server computer 14, as is well known. The parameters of the operation of the registration routine can be set by a user such that locator server computer 14 enables a user to remotely access personal computer 12 only when an authorized remote access terminal 16 is used conjointly.

Connection key 18 is configured to connect with remote access terminal 16, and similarly provides physical security enhancement to a remote access session. Connection key 18 contains authentication information, including unique identifier information assigned to a specific connection key (hereinafter “connection key identifier”). It is anticipated that in certain embodiments the connection key identifier will be stored in the memory of the connection key 40 using software and hardware security features to prevent the connection key identifier from being read, copied or changed. When connection key 18 is connected to remote access terminal 16, the connection key identifier stored on connection key 18 is configured to load onto remote access terminal 16. The connection key identifier is then used during authentication routines to determine if connection key 18 is authorized.

To set up connection key 18 as a physical authentication device, a connection key identifier can be registered with locator server computer 14 such that connection key 18 is authorized. The registration of connection key identifier can be set up in a similar way to the set up of the remote access terminal identifier, i.e. through a registration routine running on personal computer 12, as is well known. The connection key identifier can be stored in the dynamic directory at locator server computer 14, as is well known. The parameters of the operation of the registration routine can further be set by a user such that locator server computer 14 enables a user to remotely access personal computer 12 only when an authorized connection key 18 is used conjointly.

As will be readily understood, through programming at the locator server computer 14, connection key 18 and/or the remote access terminal 16, various authentication configurations can be effected. For example, by way of a programming on the connection key 18, the key will cause an authentication routine to launch on any Internet connected computer to which it is connected. The system can be configured, alternately, through programming on both the connection key 18 and the remote access terminal 16, to launch an authentication routine only when a matching key and terminal are connected. Similarly, for increased security, programming at the locator server computer 14 can require a recognized combination of a registered connection key 18 and remote access terminal 16 pair before authentication can be achieved. Through such configurations, security breaches through the loss or theft of an individual key 18 or remote access terminal 16 can be prevented.

Accordingly, through the combination of user and physical authentications as described, the remote access security is advantageously enhanced. As such, when a third party discovers an authorized user's identifier, such as login ID and password, the third party would not be able to access personal computer 10 without an authorized connection key 18 and/or remote access terminal 16.

In some embodiments, connection key 18 is further configured to enable automatic user authentication. Connection key 18 can include an executable code therein that cooperates with (remote access) computer program product 20 running on personal computer 12 as described. To set up, a user connects connection key 18 with personal computer 12, and connection key 18 gathers user identifier, such as user login and password, for storing the same in connection key 18. It is readily understood that this information can be stored in encrypted form as is well known. Therefore, the user does not need to manually authenticate himself, as the process is automated through connection key 18 and the authentication information stored therein. To use, connection key 18 is connected to remote access terminal 16 and the user identifier stored on connection key 18 is automatically loaded onto remote access terminal 16 for completing the authentication routine.

In others embodiments, connection key 18 is configured to automate both the communication request and authentication processes. Specifically, connection key 18 is configured, such as through executable codes stored therein, to cause remote access terminal 16 to generate and send to locator server computer 14 the communication request. More specifically, connection key 18 is configured to cause the communication request to be generated when connection key 18 is connected to remote access terminal 16. As such, the need for a user to manually input a communication request is eliminated. Further, the user identifier stored on connection key 18 can be included in the automated communication request, whereby both the communication request and the user authentication process can be initiated without user interaction. While the steps required by the user to effect authentication can thereby be limited to simply connecting connection key 18 to remote access terminal 16 improved security can be obtained by requiring at least one login parameter, e.g., user password, to be manually entered

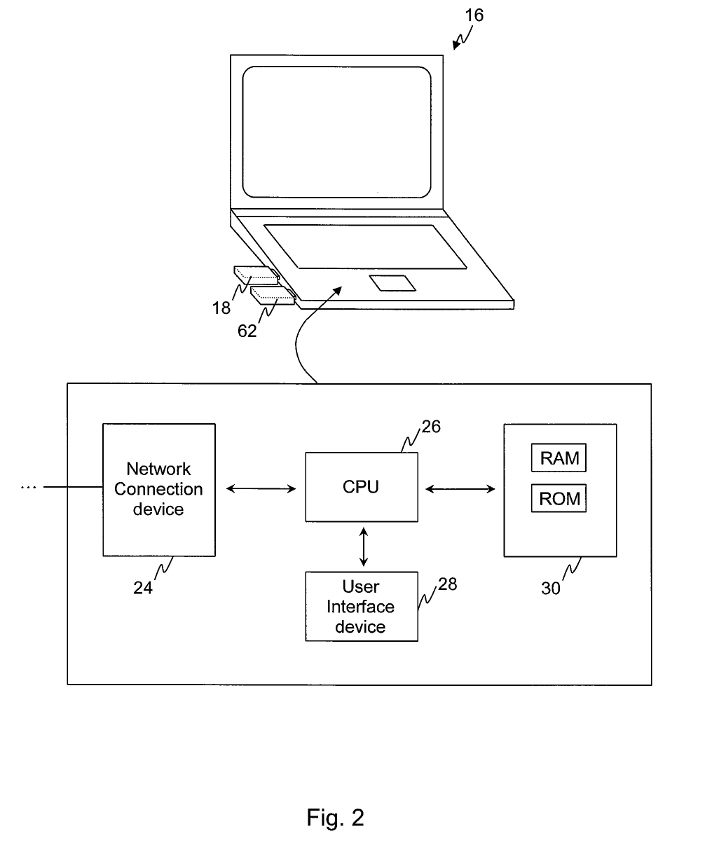

FIG. 2 is a detailed view of remote access terminal 16 according to the embodiment of the invention illustrated in FIG. 1. Remote access terminal 16 includes a network connection device 24, a microprocessor 26, a user interface device 28, and a memory 30. As will be readily understood from the discussion that follows, security of user data is enhanced through the use of the remote access terminal 16 because the remote access terminal 16 contains no storage device on which the user data will be stored and thereby remain on the remote access terminal 16.

Network connection device 24 connects remote access terminal 16 to the Internet, and for example, can be a wireless modem for connecting to a WLAN network. It will be appreciated by a person of ordinary skill in the art however that network connection device 24 may be of another type or more than one type in order to connect remote access terminal 16 to the aforementioned wired and wireless networks. For example, network connection device 24 may include a 3G modem for connection to a high-speed cellular data network.

Memory 30 includes random access memory (RAM) and read only memory (ROM). In this embodiment, ROM is a flash EEPROM, or flash memory. The ROM can be pre-installed with an operating system that provides the feature of remote access or control of the personal computer 12 and for portable computing, such as Internet access, networking connectivity and printing support. For data security, in this embodiment remote access terminal 16 contains no local non-volatile storage. The ROM is write-protected to prevent the user from storing data locally on the remote access terminal 16. All data is instead remotely stored on personal computer 12. As such, no sensitive data can be compromised from remote access terminal 16 in case it is lost or stolen.

User interface device 28 provides a hardware interface between a user of remote access terminal 16 and microprocessor (CPU) 26, and includes input and output devices as may be necessary for portable computing and to enable remote user access and/or control of personal computer 10. Examples of input devices include a keyboard and a mouse. Examples of output devices include an LCD display.

In an additional embodiment of the present invention, a system such as that depicted in FIG. 1 can be used in conjunction with an e-mail application, e.g., Outlook, Outlook Express, Windows Mail and Lotus Notes, to allow files, documents and other data to be made available to a user of the remote access terminal 16 by a user of the personal computer 12 without the necessity and risk of attaching such information to an e-mail. In this embodiment, an additional application is provided for use with the e-mail program to allow secure attachments to be provided with an e-mail. This application can be accessed by the user through the addition of a link “button” in the toolbar of the e-mail program or through the inclusion in a drop down menu in the menu bar. In an alternate embodiment, a file selection interface such as Windows Explorer can be used to invoke the application.

When secure attachments are to be provided to a third party utilizing the remote access terminal 16, the user of the personal computer 12 will invoke the secure attachment application, by way of example, by clicking on the secure attachment button. In response to this action, the program will create a link by the process described below for the user to clip and paste into the e-mail body providing a path to the attachment on the personal computer 12. Access to the attachment on the personal computer 12 is thereafter controlled through the use of public-private secure encryption keys.

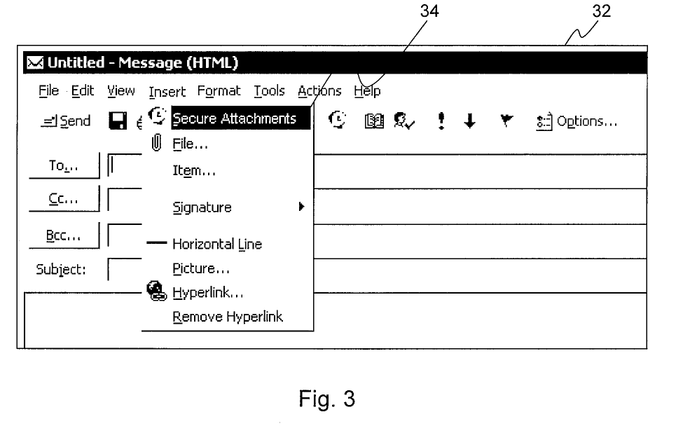

As shown in FIG. 3, in one embodiment, a secure attachment is provided from a personal computer 12 to a remote computer 16 by first creating an e-mail message 32 at the personal computer 12 using a standard e-mail application, e.g., Outlook, Outlook Express, Windows Mail and Lotus Notes. A secure attachment link is then created for insertion into the e-mail by linking to the secure attachment application either by clicking on a link in the toolbar or a link in a dropdown menu in the menu bar 34.

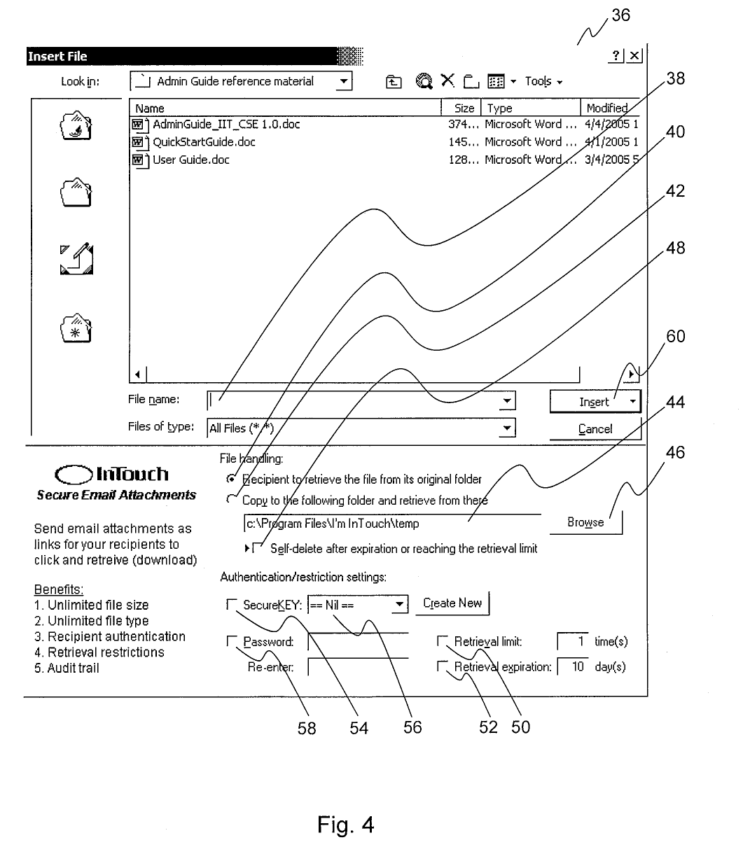

As shown in FIG. 4, once the link is selected, the user will be presented with a dialog box 36 that allows the user to identify the secure attachment file 38. The user will also be provided with the option of allowing the recipient to access the secure attachment file from its original folder 40 on the personal computer 12 or to copy the secure attachment file to another folder or location where it will be accessed 42. If the option of copying the file to another folder or location is selected the user will be presented with the option of identifying that location either by copying or typing in the path 44 or by performing a browse function to locate the appropriate folder 46 as is well known.

If the party that is creating the secure attachment selects the option of copying the file to a new location 42, the user will also be presented with the option of having that link automatically deleted after reaching a specified retrieval limit 48. The retrieval limit can be specified either by the number of times in which it is retrieved 50 or a period of time during which it can be retrieved 52.

The dialog box presented to the user creating the secure attachment will also provide the user with the option of securing the attachment through the use of a public private key pair 54. If this option is selected, the user will enter the secure key needed to access the attachment 56. As will be readily understood, this key can be entered either by typing it into an appropriate field, selecting it from a drop down menu of stored keys or, as will be discussed below, by creating a new key.

As a further security precaution, the user creating the secure attachment can create a password that will be required to retrieve the attachment. When the password option is selected 58, the user will be prompted to enter and then reenter the password as is well known. The password would then typically be delivered to the recipient separate from the e-mail providing the link to the secure attachment.

After making the desired above-noted selections and entering the appropriate information, the user will then generate the link to the attachment 60 and the link can be added directly to the e-mail. Alternatively, and in accordance with one embodiment, the links can be presented to the user creating the secure attachment in a separate dialog box which will provide the user with a summary of the elections made regarding the attachments and will present the user with the option of canceling one or more of the secure attachments or copying those to a clipboard to be pasted into the e-mail.

The process for creation of a new secure key, and subsequent use of an existing secure key, will now be described. As will be readily understood, the user can invoke the application for creation of a secure key by selecting a link while creating a secure attachment or through a link provided elsewhere on the personal computer, e.g., on the desktop.

Once invoked, the public private key pair application will prompt the user to identify a new ID for a key to be created and then generate a new key pair for that user ID. The public key of this key pair would then be provided to the remote user separate from the e-mail containing a link to a secure attachment and that public key would be utilized in accessing the attachment. In one embodiment, the public key is provided to the remote user on a USB stick 62. It should be readily understood that the secure key can be provided on the same USB stick as the connection key 18 however, as will be readily understood, because this will limit the ability to manage the public-private key pairs, it is envisioned that separate USB sticks would be used for the connection key 18 and public encryption key 62.

It should be understood that a single public-private key pair can be used for secure attachments to all remote users, a single public-private key pair can be used for multiple users or separate public-private key pairs can be used for specific users. It should also be readily understood that the user generating the public-private key pairs manages the key pairs and thus, has the ability to both create and remove key pairs as desired in order to further manage access to secure files.

Once the link to the secure attachment is created and added to an e-mail the e-mail would thereafter be sent from the personal computer 12 to the remote user 16. Once received, the remote user will open the e-mail and click on the secure attachment link. This action will cause the remote computer 16 to send a request for communication with the personal computer 12 to the locator server computer 14. The locator server computer will create a communication session between the remote computer 16 and the personal computer 12 as discussed above thereby allowing the remote computer 16 to access the secure attachment on the personal computer 12.

It will be readily understood that, through use of the foregoing described secure attachment feature, the size limitations for e-mail imposed by e-mail services can be overcome. In addition, because the e-mail attachments are being received from trusted parties, e-mail filters can be bypassed for file types such as .exe without the fear of virus contamination. An additional advantage of the foregoing secure attachment program is that restrictions can be placed on access and audit trails can be created for received attachments.

It will also be readily understood that when used for providing secure attachments, it is intended that a user at the personal computer in FIG. 1 will be sending e-mails and a separate user at the remote terminal 16 will be receiving the e-mails. It will also be readily understood that any number of remote access terminals 16 can receive e-mails from the personal computer 12 having secure attachment links. Conversely, when the system 10 is used for remote access an/or remote control of personal computer 12 it is intended that there will only be a user at remote computer 16 and that user will be remotely accessing or controlling an unmanned personal computer 12 to which that user has access rights. Of course, the remote computer 16 can be used with the system as described herein to remotely control the personal computer 12 to send an e-mail containing a secure attachment to a third party computer.

Other embodiments of remote access terminal 16 have been contemplated. Although in the embodiment as shown in FIG. 2, memory 30 of remote access terminal 16 for data security considerations contains only volatile storage, a person of ordinary skill in the art will understand that the invention is not so limited. For example, a recreational user's desire to store multimedia locally on remote access terminal 16 may trump his concern over data security. In those circumstances, remote access terminal 16 may be a laptop computer with non-volatile memory storage, as is well known. Security in remote access sessions can still be provided by a combination of user authentication and physical connection key authentication according to the present invention.

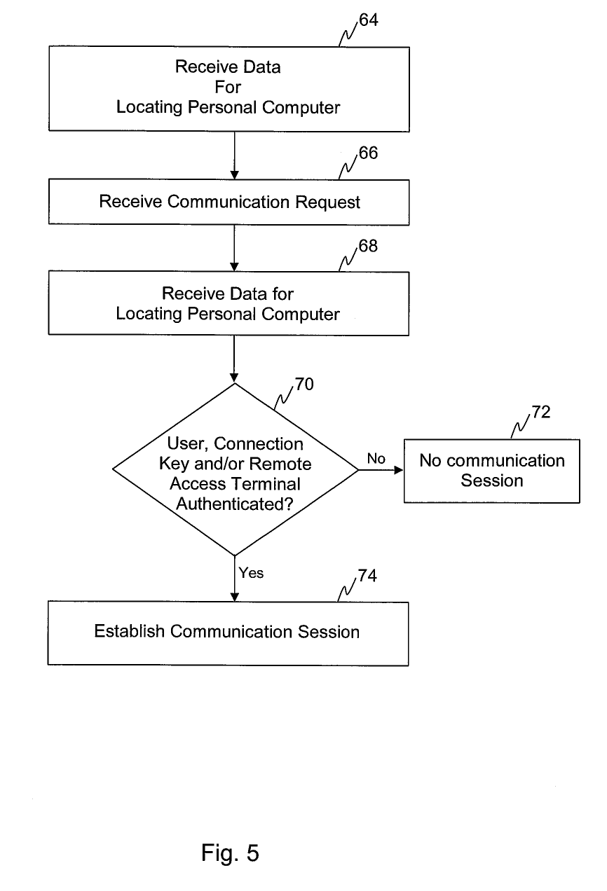

FIG. 5 is a flow chart depicting a method for providing remote access/control to a personal computer (such as personal computer 12 as shown in FIG. 1). A signal that includes data for locating a personal computer (such as personal computer 12 as shown in FIG. 1) is first received from personal computer (64). The signal that includes data for locating personal computer 12 includes an IP address associated with personal computer 12. The method proceeds to receive from remote access terminal 16 a request for communication with personal computer 12 (hereinafter “communication request”) (66). In this embodiment, the location of personal computer 12 and the communication request are received at a locator server computer (such as locator server computer 14 as shown in FIG. 1). The communication request may be initiated by the input of a user through remote access terminal 16. Alternatively, the communication request may be initiated by connection key 18 without user input.

The method next proceeds to receive authentication information from remote access terminal 16 (68). The authentication information may be received at locator server computer 14 and/or personal computer 12. The authentication information may contain identifier information to authenticate a user of remote access terminal 16, or to authenticate remote access terminal 16 and/or connection key 18. In a preferred embodiment, authentication information contains connection key identifier information stored on connection key 18 and loaded onto remote access terminal 16 when connected thereto. In some embodiments, authentication information may further contain user identifier information stored at connection key 18 that is configured to load onto remote access terminal 16 when connected. Alternatively, the user identifier can be input by the user through an input interface. In other embodiments, authentication information may also contain remote access terminal identifier information associated with remote access terminal 16, as discussed above.

To enhance security, the system can be configured to require connection key 18 and remote access terminal 16 be used in connection with a remote access session. The authentication process is performed in accordance with the configured parameters to determine if the conditions for authentication are satisfied (70). Specifically, personal computer 12 and/or locator server computer 14 authenticates the received authentication information to determine if the user of remote access terminal 16, remote access terminal 16, and/or connection key 18 is authorized.

Based at least in part on the authentication information, one or more communication sessions between remote access terminal 16 and personal computer 12 is created. In the preferred embodiment, once locator server computer 14 has determined the conditions for authentication are satisfied, a communication session is established between the personal computer 12 and the remote computer 16 (74). In one embodiment the remote computer 16 accesses a file within the personal computer 12 directly from the memory of the personal computer 12. Alternatively the remote computer 16 can access a file within the personal computer 12 indirectly from the memory of the personal computer 12. U.S. Pat. No. 6,928,479, discloses both direct and indirect connection methods between personal computer 12 and remote access terminal 16, the disclosures of which are incorporated herein by reference.

If however the conditions for authentication are not satisfied, no communication session is established between personal computer 12 and remote access terminal 16 (72). In some embodiments, in response to the receipt of the communication request in step 66, personal computer 12 or locator server computer 14 may further prompt the user to enter authentication information. For added security, in some embodiments, it is desirable to include a further authentication routine once the communication session(s) is established between remote access terminal 16 and personal computer 12.

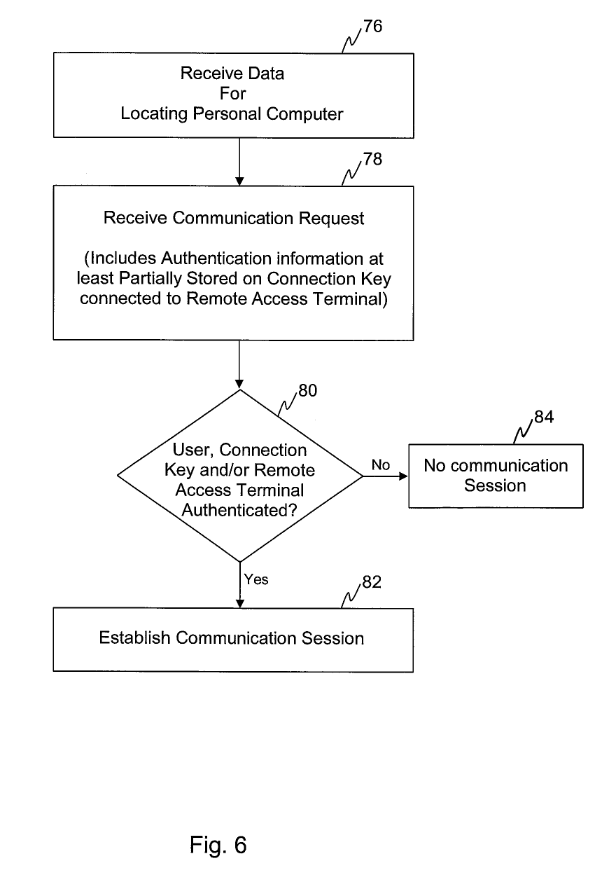

FIG. 6 is a flow chart depicting a method for providing remote access/control to personal computer 12, in accordance with another embodiment of the present invention. In this embodiment, the locator server computer receives information for locating the personal computer 12 (76). The authentication information is included in the process for requesting communication with the personal computer and received at locator server computer 14 (78). Accordingly, as compared to the embodiment as illustrated in FIG. 4, the authentication information is not separately received and the method proceeds directly to the authentication routine (80). A communication session is established 82 or not 84 depending on the outcome of the authentication routine 80.

While embodiments of the method of the invention are described in the order of steps as shown, a reasonable person of ordinary skill in the art would understand that the order is not so limited. For example, in some embodiments, the communication sessions between personal computer 12 and remote access terminal 16 may be established before performing the authentication routine.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of sharing of data files comprising the steps of:
receiving at a second computer a communication that includes data for locating a first computer on the Internet;
receiving at said second computer a request from a third computer to connect to a file within said first computer identified to said third computer by said first computer; and
creating a communication session between said third computer and said first computer that allows said third computer to access the said file directly from a memory of said first computer, or indirectly via said first computer.

2. The method of claim 1 wherein said third computer accesses the said file directly from a memory of said first computer.

3. The method of claim 1 wherein said third computer accesses the said file indirectly from a memory of said first computer.

4. The method of claim 2-3 further comprising the step of the second computer receiving authentication information from the third computer before permitting access to the file on the first computer.

5. The method of claim 4 wherein the step of receiving authentication information includes the step of receiving data encrypted with a public encryption key assigned to a user of the third computer.

6. The method of claims 2 wherein the third computer receives an identification of the file to be accessed from the memory of the first computer through a link provided in an e-mail from the first computer.

7. The method of claim 6 further comprising the step of the first computer limiting the number of times the third computer can access the file.

8. The method of claim 7 wherein the file is an executable file.

9. The method of claim 6 further comprising the step of the first computer limiting the amount time during which the third computer can access the file.

10. The method of claim 9 wherein the file is an executable file.

11. The method of claim 6 further comprising the step of the second computer limiting the number of times the third computer can access the file.

12. The method of claim 1 wherein the step of receiving a communication that includes data for locating said first computer on the Internet occurs after the step of receiving a request from a third computer to connect to a file within said first computer.

13. A system comprising:
a personal computer linked to the Internet and associated with an IP address, the personal computer being configured to send a signal that includes data for locating the personal computer;
a locator server computer linked to the Internet and associated with a static IP address, the locator server computer being configured to receive from the personal computer a signal that includes data corresponding to the data for locating the personal computer;
a remote access terminal linked to the Internet and capable of sending requests for communication with the personal computer to the locator server computer;
a connection key configured to physically, electrically and removably connect with the remote access terminal;
wherein the remote access terminal is configured to generate a request for communication with the personal computer based upon input from the connection key;
wherein the locator server computer is configured in response at least in part to the request for communication with the personal computer to create a communication session between the personal computer and the remote access terminal based on the signal that includes data for locating the personal computer.

14. The system of claim 13 wherein the IP address of the personal computer is associated with an IP address that cannot be reached publicly from the Internet.

15. The system of claim 13 wherein the IP address of the personal computer is associated with an IP address that can be reached publicly from the Internet.

16. The system of claim 14-15, wherein at least one of the locator server and the personal computer is configured to determine if at least one of a user of the remote access terminal, the remote access terminal, and the connection key is authorized to access the personal computer.

17. The system of claim 16, wherein the locator server computer is configured to create the communication session when at least one of a user of the remote access terminal, the remote access terminal, and the connection key is authorized to access the personal computer.

18. The system of claim 16, wherein the connection key is configured to cause the remote access terminal to generate and send to the locator server computer the request for communication with the personal computer when the connection key is physically, electrically, and removably connected to the remote access terminal.

19. The system of claim 16, wherein the input from the connection key comprises authentication information that includes connection key identifier information for authenticating the connection key to at least one of the personal computer and the locator sever.

20. The system of claim 19, wherein the remote access terminal contains only volatile storage.

21. A method for providing remote access/control to a personal computer, comprising:
receiving a signal at a locator server computer that includes data for locating the personal computer
receiving a request at the locator server computer, from a remote access terminal, for communication with the personal computer;
receiving authentication information from the remote access terminal, the authentication information being at least partially stored on a connection key physically, electrically and removably connected to the remote access terminal; and
creating a communication session between the remote access terminal and the personal computer based at least in part on the authentication information.

22. The method according to claim 21 further comprising determining if the connection key is authorized to access the personal computer.

23. The method according to claim 22 further comprising determining if the remote access terminal is authorized to access the personal computer.

24. The method according to claim 23, wherein the authentication information is partially input by a user of the remote access terminal and wherein the authentication information stored on the connection key comprises user identifier information, connection key identifier information and remote access terminal identifier information.

25. A system comprising:
a personal computer linked to the Internet and associated with an IP address, the personal computer being configured to send a signal that includes data for locating the personal computer;
a locator server computer linked to the Internet and associated with an IP address that can be reached publicly from the Internet including a public static IP address, the locator server computer being configured to receive from the personal computer a signal that includes data corresponding to the data for locating the personal computer;
a remote access terminal linked to the Internet and capable of sending requests for communication with the personal computer to the locator server computer;
a connection key physically, electrically and removably connected to the remote access terminal;
wherein the remote access terminal is configured to generate a request for communication with the personal computer based upon input from a user;
where the locator server computer is configured in response at least in part to the request for communication with the personal computer to create a communication session between the personal computer and the remote access terminal based on the signal that includes data for locating the personal computer.

26. The system of claim 25 wherein the personal computer is associated with an IP address that cannot be reached publicly from the Internet.

27. The system of claim 25 wherein the personal computer is associated with an IP address that can be reached publicly from the Internet.

28. The system of claim 26-27 wherein the connection key is configured to at least partially store authentication information of the user at the remote access terminal.

29. The system of claim 26-27 wherein the remote access terminal generates a request for communication with the personal computer based upon input of information caused by a user of the remote access terminal.

30. The system of claim 28 wherein the remote access terminal generates a request for communication with the personal computer based upon input of information caused by the connection key at the remote access terminal.
